(19) United States
(12) Patent Application Publication
(10) Pub. No.: US 2021/0009180 A1
(43) Pub. Date: Jan. 14, 2021

(54) Pallet Loading Height Limiter

(71) Applicant: Thomas Frantisekovich Kovach, Mount Juliet, TN (US)

(72) Inventor: Thomas Frantisekovich Kovach, Mount Juliet, TN (US)

(73) Assignee: 1SG Enterprises, Mount Juliet, TN (US)

(21) Appl. No.: 16/505,707

(22) Filed: Jul. 9, 2019

(51) Int. Cl. B62B 3/06; B65D 19/42; B65D 19/38

(52) U.S. Cl. CPC B62B 3/06; B65G 69/24; B65D 19/385; B65D 19/42

(57) ABSTRACT

The Pallet Loading Height Limiter is a very simple, and yet effective, non-powered, adjustable device for helping warehouse workers keep a shipping pallet load within safe and proper limits for height (and, consequentially, also weight). The device rolls on locking casters for easy use and storage. The device's frame has reinforcing brackets that minimize damage from passing forklifts, etc. The device's design makes it easy to repair if it is ever damaged. Because there is no globally-accepted standard for pallet sizes, this device may be made in various sizes (usually determined by country of origin of the pallet). That said, the North American pallet size (40″ by 48″) is the standard used for this application. This device works equally well with stringer- or block-type pallets. Using this device should help minimize material-handling injuries to workers that handle loaded pallets.

### CROSS-REFERENCES

A diligent search showed no similar applications nor existing patents.

Specifically, using the International Patent Classification (IPC) system, this applicant found no similar device. Classification B65D 19/38 (details or accessories for pallets) seems the best category. This applicant searched at least 45 different IPC categories.

### OTHER REFERENCES

There are no sequence listings nor other references related to this invention.

### BACKGROUND OF THE INVENTION

The inventor was working as a grocery clerk in a supermarket. One day, the inventor had to relocate a pallet that was loaded with produce. It turned out that the pallet was overloaded (by perhaps 150 to 200 pounds more than an average pallet). Even though he was properly using a pallet jack, within a matter of seconds the inventor got three abdominal hernias. While home recovering, the inventor came up with an idea that easily prevents pallets from being overloaded.

### BRIEF SUMMARY OF THE INVENTION

This device enables a warehouse supervisor to quickly establish the maximum height to which a pallet of goods may be loaded. The device is adjustable, so that loads of lighter-density goods may be stacked higher than loads of heavier-density goods. Once the height is set, the device provides an easy-to-understand boundary, so that warehouse workers may quickly and consistently load pallets within safe and proper height and weight limits.

### BRIEF DESCRIPTION OF THE DRAWINGS

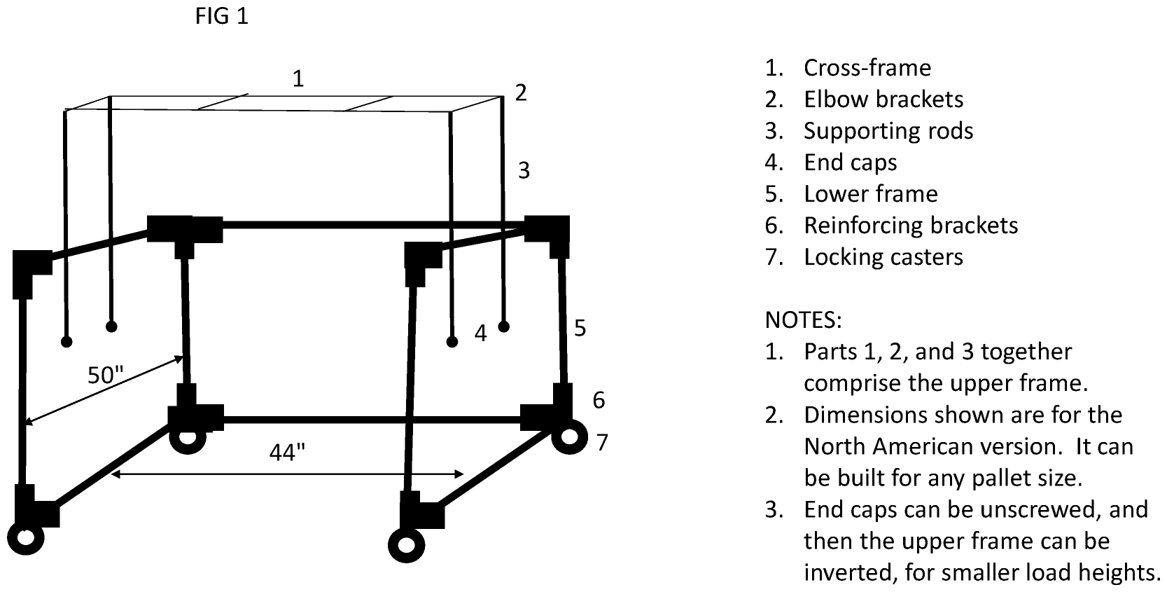

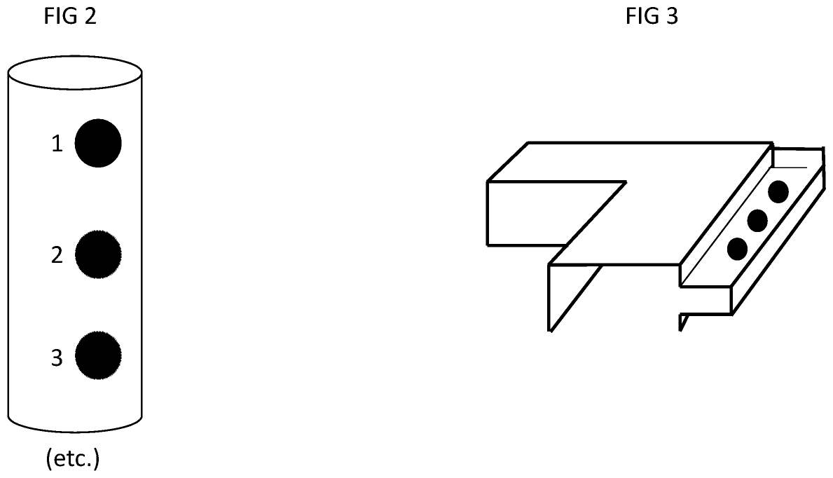

Drawings included with this application consist of three figures on two sheets (FIG. 1 is on Sheet 1. FIGS. 2 and 3 are on Sheet 2). FIG. 1 includes seven reference characters. No photographs are included.

### DETAILED DESCRIPTION OF THE INVENTION

The device is a metal frame, on wheels, with one end open to fit around a standard-size shipping pallet. The upper portion of the frame has holes (drilled vertically), into which four supporting rods slide up and down for adjustment. The rods support a cross-frame, which is the functional part of the Pallet Loading Height Limiter. The user sets the height adjustment for the type of load and its density. The cross-frame then acts as a boundary, so that warehouse workers may consistently load similar pallets within a thus-established safe and proper limit. (FIG. 1)

The supporting rods have holes (drilled horizontally), at one-inch intervals, into which locking pins can be inserted. The locking pins are attached to the frame with corresponding safety cables—the other end of which is screwed into the frame through an eyelet—so that the pins are not accidentally separated from the device. By inserting the pins into the holes, the cross-frame height can be adjusted quickly and easily. Once adjusted, the cross-frame remains in place securely. The rods have end-caps that prevent them from getting separated from the frame

A distinguishing feature of the supporting rods is that they have a numerical scale near each hole, so that users can ensure that the cross-frame is level and loads are consistent. (FIG. 2)

The cross-frame is attached to the supporting rods by four elbow-brackets. Using this arrangement allows for ease of manufacture, because all four supporting rods can be made the same way. Also, use of the elbow brackets allows for easy repair, in case the cross-frame is ever damaged. (But, the design of the device is such that damage to that area is unlikely.)

The sides of the frame are intentionally left open, instead of using any type of cross-beam in the frame, so that the device will not hinder workers as they load the pallet from any side. In order to make up for the lack of cross-beams in the main frame, the corners have reinforcing brackets that are bolted into place around the outside of those portions of the frame. (By bolting the brackets around the frame, instead of welding them, the device may later be economically repaired if it gets damaged by a passing forklift, etc.)

Locking casters (wheels) on the bottom of the frame enable the device to be quickly and easily rolled into place for use, and then rolled away for storage when not in use. Locking the casters enhances safety while in use, and minimizes potential damage while in storage.

The distinguishing feature of the reinforcing brackets is a ridge around the edges. The ridge provides not only a surface into which holes can be drilled (for the small bolts that hold the two halves of the bracket together), but also the ridge provides extra stiffness that strengthens the corners against any side-pressure or impact. By having this arrangement, the device can be repaired easily from a stock of spare brackets that are kept on-hand by the end user. (FIG. 3)

This invention, the “Pallet Loading Height Limiter”, is distinct from the “Pallet Loading Device” (U.S. Pat. No. 2,701,650A, issued: Feb. 8, 1955), because this invention does not do the loading. It only acts as a guide for the people doing the loading.

This invention differs from the “Pallet Loading Apparatus” (U.S. Pat. No. 3,833,132A, issued: Sep. 3, 1969) for a similar reason. That invention loads a pallet one level at a time, but requires people to load the machine first, thus creating a cumbersome and expensive two-step process. The “Pallet Loading Height Limiter” has no mechanical processes; thus, it is simpler. The people loading the pallet are still fully in control of any variables and nuances of the load.

The “Pallet Loading Height Limiter” differs in several substantial ways from the “Method of and Apparatus for Loading Pallets” (U.S. Pat. No. 2,979,872A; issued: Sep. 28, 1956), which is based upon an entire system of robots that load a pallet from either side simultaneously, and then loads the pallets into shipping containers.

1. A rolling metal framework that limits the height to which workers may load a shipping pallet, and which consists of:
a) a main lower frame,
b) a set of locking casters below, and
c) a set of reinforcing brackets at each of the lower corners, and
d) an adjustable upper frame, which is made of supporting rods that
e) support a cross-frame, which
f) is the functional part of the device,
whereby workers are limited in the height to which the pallet may be loaded, and thus keeps the load within a predetermined standard of load height and weight, and thus minimizes potential injuries to workers that then move the loaded pallet from one place to another.
